(19) United States
(12) Patent Application Publication
(10) Pub. No.: US 2012/0000757 A1
(43) Pub. Date: Jan. 5, 2012

(54) SWITCH AND ILLUMINATION UNIT

(75) Inventor: Takayuki IKEDA, Makinohara-shi (JP)

(73) Assignee: YAZAKI CORPORATION, Tokyo (JP)

(21) Appl. No.: 13/174,855

(22) Filed: Jul. 1, 2011

(30) Foreign Application Priority Data
Jul. 2, 2010 (JP) P2010-151929

(51) Int. Cl. H01H 9/00

(52) U.S. Cl. 200/310

(57) ABSTRACT

A switch has a pressing operation part capable of pressing and operating a pressing part, the switch having an LED placed on a flexible printed wiring board and pinched by the pressing operation part and the pressing part, characterized in that the pressing operation part has a transmission part for transmitting light emitted by the LED to a side of an operation surface of said pressing operation part.

### BACKGROUND OF THE INVENTION

1. Field of the Invention

The present invention relates to a switch and an illumination unit.

2. Description of the Related Art

Conventionally, a switch or an illumination unit for turning on and off a light by the switch may have premium accents in a pressing operation part of its switch. Hence, a switch constructed so that a light emitting part such as an LED (Light Emitting Diode) is provided and light emitted from this light emitting part is transmitted to a pressing operation part is proposed (see Patent Reference 1). In this switch, push-button units are juxtaposed to a body part of the switch fixed and arranged on a substrate and also the LED for illuminating a push button is fixed and arranged on the substrate of a lower position of the push button and the body part of the switch is used as a guide in the case of moving the push-button units by a pressing force.

Patent Reference 1: JP-A-2004-165143

However, according to the switch of Patent Reference 1, a position of the push button changes by a pressing operation of the push button, so that a distance between the push button and the LED fixed and arranged on the substrate changes. As a result, there was a problem that intensity of light passing through the push button changes before and after the pressing operation of the push button.

### SUMMARY OF THE INVENTION

The invention has been implemented in view of the above, and an object of the invention is to provide a switch capable of stabilizing intensity of light passing through a pressing operation part, and an illumination unit including this switch.

In order to solve above problem, a first aspect of the invention provides with a switch having a pressing operation part capable of pressing and operating a pressing part, the switch having an LED placed on a flexible printed wiring board and pinched by the pressing operation part and the pressing part, characterized in that the pressing operation part has a transmission part for transmitting light emitted by the LED to a side of an operation surface of said pressing operation part.

A second aspect of the invention provides with the switch defined in the first aspect of the invention, wherein the pressing operation part or the pressing part has a joining part for pinching the LED by the pressing operation part and the pressing part and joining the pressing operation part to the pressing part.

A third aspect of the invention provides with the switch defined in the first aspect of the invention, wherein the LED is provided just under the pressing operation part and is pinched by the pressing operation part and the pressing part so as to abut on the pressing operation part.

A fourth aspect of the invention provides with an illumination unit which includes a switch as defined in the first aspect of the invention and switches between turn-on and turn-off of an illumination part by pressing and operating said switch, characterized in that the flexible printed wiring board has a first connection part for connecting the switch to the illumination part, and a second connection part branched from the first connection part by a slit provided in the flexible printed wiring board, and the LED is placed on the second connection part and is pinched by the pressing operation part and the pressing part.

In the switch according to the first aspect of the invention, light emitted by the LED pinched by the pressing operation part and the pressing part passes through the side of the operation surface of the pressing operation part, so that even when the pressing operation part is pressed and operated, a distance between the pressing operation part and the LED does not change before and after the pressing operation. Therefore, intensity of the light passing through the pressing operation part can be stabilized regardless of the pressing operation of the pressing operation part.

In the switch according to the second aspect of the invention, the joining part pinches the LED by the pressing operation part and the pressing part and joins the pressing operation part to the pressing part, so that the LED can surely be pinched by the pressing operation part and the pressing part.

In the switch according to the third aspect of the invention, the LED is provided just under the pressing operation part and is pinched by the pressing operation part and the pressing part so as to abut on the pressing operation part, so that light of the transmission part can be emitted using a small amount of light. Moreover, leakage of light can be reduced.

In the illumination unit according to the fourth aspect of the invention, the second connection part is branched from the first connection part by providing the slit, so that the LED can be arranged on the same flexible printed wiring board as the first connection part. As a result, the number of components can be reduced.

### BRIEF DESCRIPTION OF THE DRAWINGS

FIG. 1 shows an illumination apparatus to which a switch and an illumination unit which are an embodiment of the invention are applied.

FIG. 2 is an exploded perspective view of the illumination apparatus.

FIG. 3 is an enlarged perspective view of a switch operation part.

FIG. 4 is a perspective view showing the illumination unit.

FIG. 5 is an exploded perspective view of the illumination unit.

FIG. 6 is a view describing a state before an illumination LED of the illumination unit is arranged.

FIG. 7 is a top view of the illumination apparatus.

FIG. 8 is a sectional view showing a part of a sectional view taken on line A-A of the illumination apparatus shown in FIG. 7.

### DESCRIPTION OF THE PREFERRED EMBODIMENTS

A preferred embodiment of a switch and an illumination unit according to the invention will hereinafter be described in detail with reference to the drawings. In addition, this invention is not limited by this embodiment.

### Embodiment

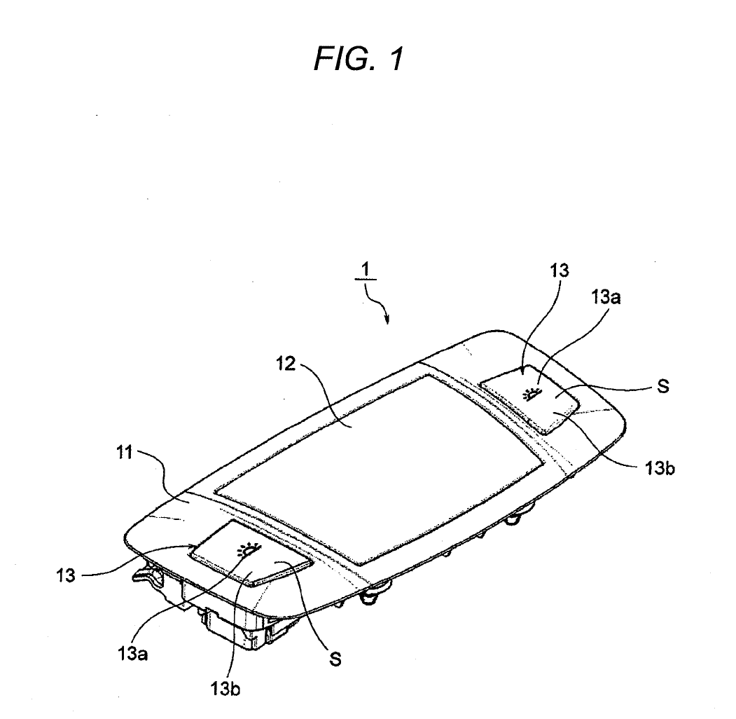

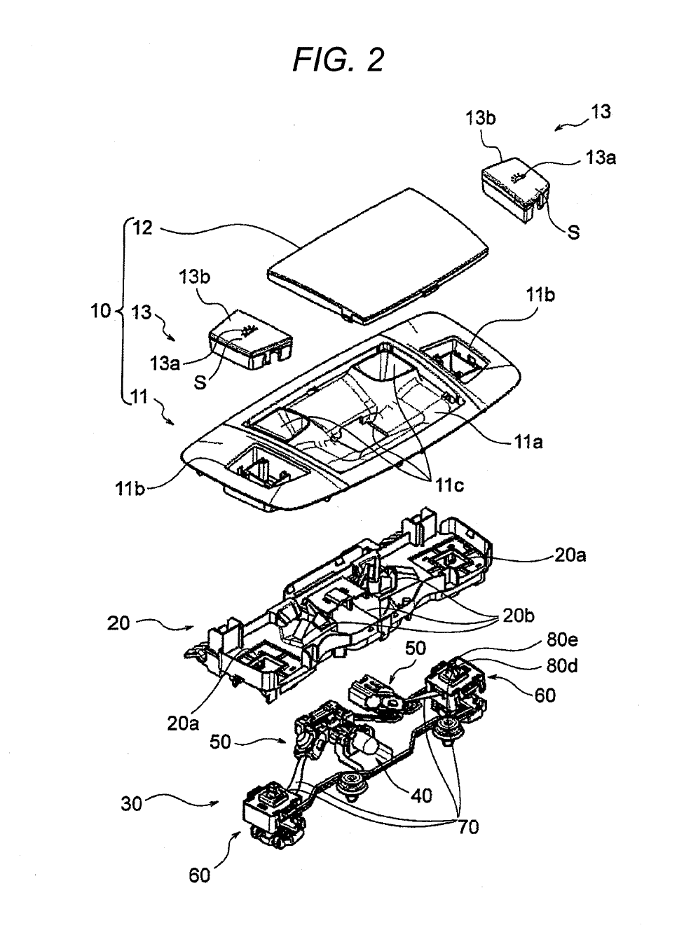

FIG. 1 shows an illumination apparatus to which a switch and an illumination unit which are the embodiment of the invention are applied. FIG. 2 is an exploded perspective view of the illumination apparatus shown in FIG. 1. The illumination apparatus 1 is arranged on, for example, a roof of the inside of a vehicle, and illuminates the inside of the vehicle. The illumination apparatus 1 has a design part 10, a housing 20 and an illumination function part 30 as shown in FIG. 2. The illumination apparatus 1 turns on or off a light by pressing and operating a switch operation part 13 as a pressing operation part.

The design part 10 has a bezel 11, a lens body 12 and the switch operation part 13. In the bezel 11, the external form has a rectangular shape and a recess 11a for lens is formed in the center and operation receiving holes 11b are respectively formed in the right and left outside positions. Three holes 11c for illumination are opened in the recess 11a for lens. The lens body 12 is attached to the inside of a room in the recess 11a for lens.

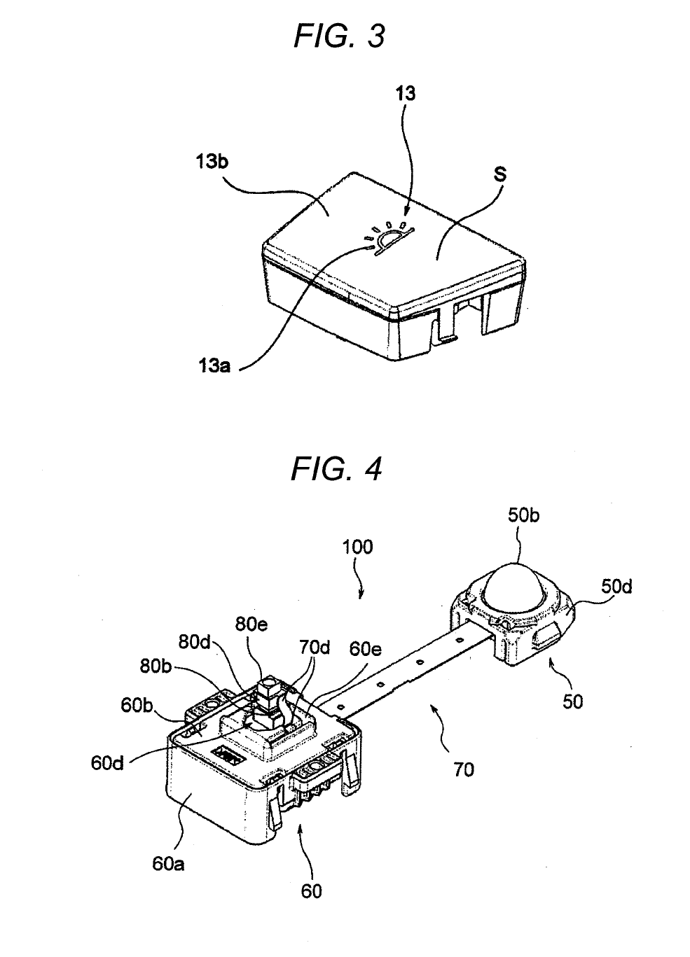

The switch operation part 13 is an operation part which is joined to a switch mechanism 80 described below and presses and operates a pressing part of the switch mechanism 80. The switch operation part 13 is received in the operation receiving hole 11b so that the pressing part can be pressed and operated. The switch operation part 13 is made of, for example, a light diffusion material capable of transmitting light, and has a display part 13a as a transmission part which transmits light and a paint part 13b which does not transmit light as shown in FIG. 3. Paint which does not transmit light is applied to a surface of the switch operation part 13. The display part 13a is the transmission part which transmits light emitted by an illumination LED 80e described below to the side of an operation surface S of the switch operation part 13. The display part 13a is arranged in a position of the center of the operation surface S. The display part 13a is formed by removing the paint of the surface by, for example, laser irradiation.

In the housing 20, rectangular switch projection holes 20a are opened in positions corresponding to the operation receiving holes 11b of the right and left outsides of the bezel 11. The housing 20 has openings 20b for illumination in positions corresponding to the three holes 11c for illumination of the bezel 11. The housing 20 is attached to the bezel 11 by a locking part (not shown).

The illumination function part 30 has a first illumination part 40 implemented by a light bulb etc., two second illumination parts 50 and two switch function parts 60 as shown in FIG. 2. The first illumination part 40 and the second illumination parts 50 are electrically connected to the switch function parts 60. The second illumination parts 50 are electrically connected to the switch function parts 60 through flexible printed wiring boards 70 (hereinafter called an FPC). The respective first illumination part 40 and the second illumination parts 50 are arranged in the positions corresponding to the holes 11c for illumination, and the room inside is irradiated with illumination light from each of the illumination parts through the lens body 12.

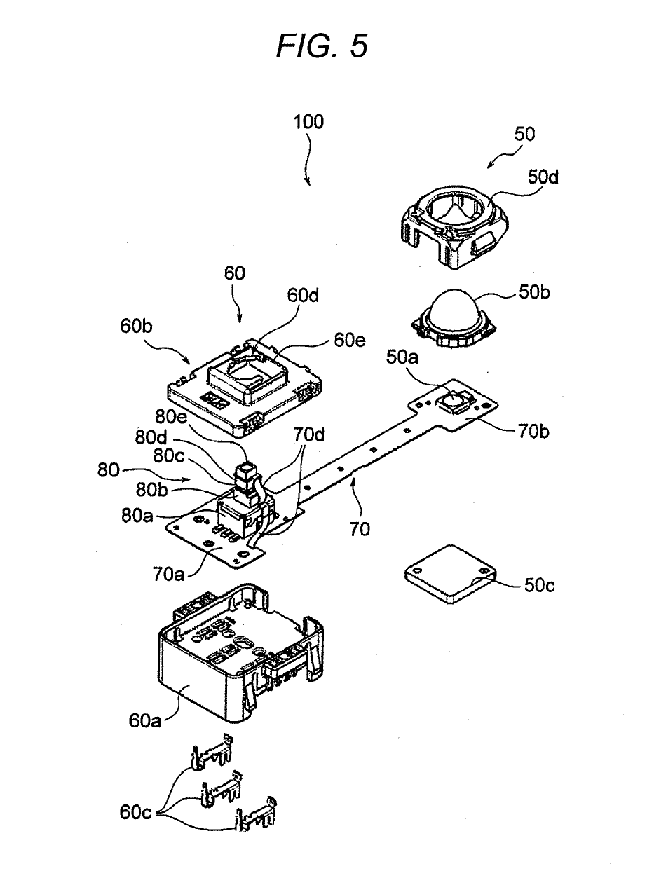

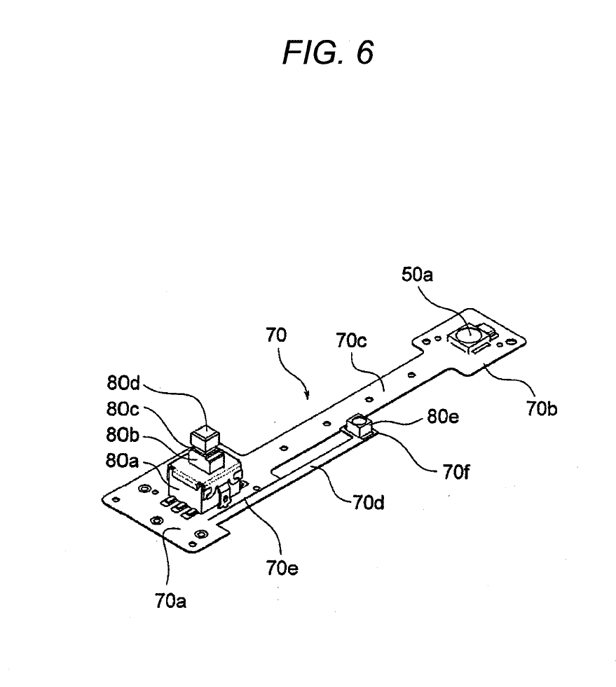

Here, an illumination unit 100 will be described using FIGS. 4 to 6. FIG. 4 is a perspective view showing the illumination unit. FIG. 5 is an exploded perspective view of the illumination unit. FIG. 6 is a view describing a state before an illumination LED of the illumination unit is arranged.

The illumination unit 100 has the FPC 70, the second illumination part 50 and the switch function part 60 as shown in FIG. 4.

The FPC 70 has a switch mounting part 70a, an illumination mounting part 70b, a first strip-shaped part 70c as a first connection part, a second strip-shaped part 70d as a second connection part, and an LED mounting part 70f as shown in FIG. 6. In the FPC 70, the switch mounting part 70a is coupled to one end of the first strip-shaped part 70c and the illumination mounting part 70b is coupled to the other end of the first strip-shaped part 70c. The second strip-shaped part 70d is branched from the first strip-shaped part 70c by a slit 70e provided in the FPC 70. In the second strip-shaped part 70d, the LED mounting part 70f is coupled to the distal end of a strip-shaped portion extending from the vicinity of the switch mounting part 70a.

The second illumination part 50 has an LED 50a mounted on the illumination mounting part 70b, a lens 50b with a hemispherical external form for covering the LED 50a, a heat-radiating plate 50c implemented by an aluminum plate etc., the heat-radiating plate on which the illumination mounting part 70b is placed, and a lens holder 50d fitted into the heat-radiating plate 50c so as to project the lens 50b as shown in FIG. 5.

The switch function part 60 has the switch mechanism 80 mounted in the switch mounting part 70a, a switch housing 60a for receiving the switch mounting part 70a, and a switch cover 60b.

The switch mechanism 80 has a switch body part 80a, a guide part 80b, a trunk part 80c and a head part 80d. The switch body part 80a has a terminal etc. in the inside. The switch body part 80a has a function of connection to a power source. The guide part 80b projects to an upper portion of the switch body part 80a, and guides the trunk part 80c upward and downward movably. The head part 80d has a rectangular cross section and is provided in an upper portion of the trunk part 80c. The head part 80d is the portion pressed by a pressing operation through the switch operation part 13 as a pressing part.

Also, the switch mechanism 80 has the illumination LED 80e implemented by an LED. The illumination LED 80e has a rectangular cross section and is provided on an upper surface of the head part 80d in a state of being mounted in the LED mounting part 70f. Here, the second strip-shaped part 70d is upward folded and is formed in a state of extending to the upper surface of the head part 80d as shown in FIG. 5. In addition, the second strip-shaped part 70d is set at a loose length so as to be able to cope with upward and downward movement of the head part 80d. The switch mechanism 80 is connected to a power source of the vehicle body side through bus bars 60c provided in a bottom surface of the switch housing 60a. The illumination LED 80e is electrically connected through the second strip-shaped part 70d.

The switch cover 60b is fitted into the switch housing 60a so as to project the switch mechanism 80. An opening 60d for switch for projecting the switch mechanism 80 is formed in the switch cover 60b. The opening 60d for switch has an opening 60e for FPC. The opening 60e for FPC is the portion for enlarging the opening 60d for switch in order to extend the second strip-shaped part 70d to the head part 80d.

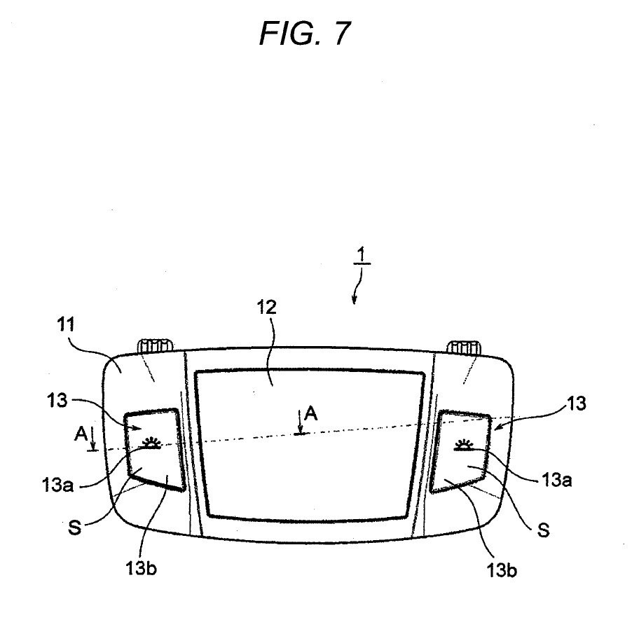

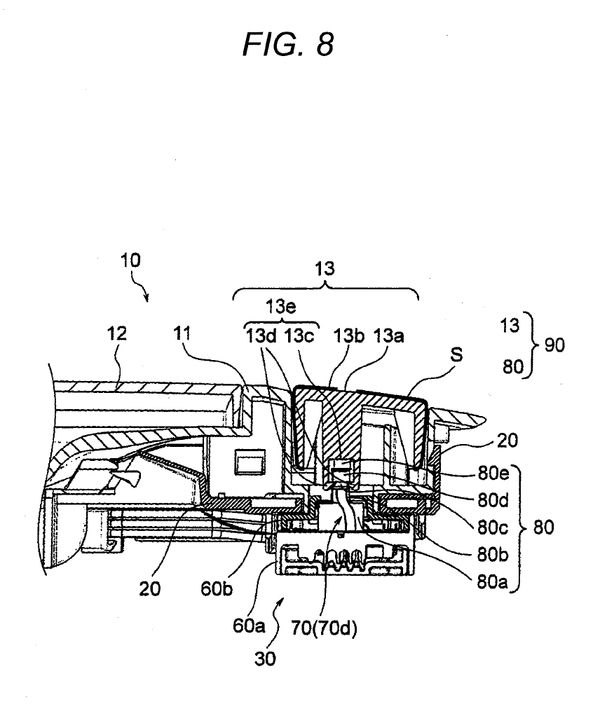

Next, a state of attaching the design part 10, the housing 20 and the illumination function part 30 will be described using FIGS. 7 and 8. FIG. 7 is a top view of the illumination apparatus 1. Also, FIG. 8 is a view showing a part of a sectional view taken on line A-A of the illumination apparatus 1 shown in FIG. 7.

The switch operation part 13 has a joining part 13e as shown in FIG. 8. The joining part 13e has an abutting part 13c in which a flat surface abutting on an upper surface is formed, and a hook part 13d which has a hooked cross section and is hooked to a lower portion of the head part 80d. The joining part 13e is means for pinching the illumination LED 80e by the upper surface of the head part 80d and the abutting part 13c of the switch operation part 13 and joining the switch operation part 13 to the head part 80d. The illumination LED 80e is provided just under the switch operation part 13 and is pinched by the switch operation part 13 and the head part 80d so as to abut on the abutting part 13c of the switch operation part 13.

Here, the illumination LED 80e could be temporarily fixed to the upper surface of the head part 80d using, for example, a double-faced tape when the switch operation part 13 is attached to the switch mechanism 80. In this case, the illumination LED 80e is permanently fixed by being assembled so as to be pinched by the switch operation part 13 and the head part 80d.

As shown in FIG. 8, when the design part 10, the housing 20 and the illumination function part 30 are attached, the illumination LED 80e moves while maintaining a state of abutting on the switch operation part 13 just under the switch operation part 13 in the case of pressing the switch operation part 13. That is, even when the switch operation part 13 is pressed and operated, a distance between the display part 13a and the illumination LED 80e is maintained constant. As a result, a switch 90 in which the switch operation part 13 is joined to the switch mechanism 80 functions as the switch.

In this embodiment, light emitted by the illumination LED 80e pinched by the switch operation part 13 and the head part 80d in the state of abutting on the switch operation part 13 passes through the side of the operation surface S of the switch operation part 13, so that even when the switch operation part 13 is pressed and operated, a distance between the switch operation part 13 and the illumination LED 80e does not change before and after the pressing operation. Therefore, intensity of the light passing through the switch operation part 13 can be stabilized.

Also, in this embodiment, the joining part 13e pinches the illumination LED 80e by the switch operation part 13 and the head part 80d and joins the switch operation part 13 to the head part 80d, so that the illumination LED 80e can surely be pinched by the switch operation part 13 and the head part 80d.

Further, in this embodiment, the illumination LED 80e is arranged in a position abutting on the switch operation part 13 just under the switch operation part 13, so that light of the display part 13a can be emitted using a small amount of light. Moreover, leakage of light can be reduced.

Also, in this embodiment, the second strip-shaped part 70d is branched from the first strip-shaped part 70c by providing the slit 70e, so that the illumination LED 80e can be arranged on the same FPC 70 as the first strip-shaped part 70c. As a result, the number of components can be reduced.

In addition, in this embodiment, the case of arranging the display part 13a in a position of the center of the operation surface S is illustrated, but it is not limited to this case, and light emitted by the illumination LED 80e could pass through the side of the operation surface S of the switch operation part 13. For example, the display part 13a may be arranged to the side upper than the position of the center of the operation surface S.

Also, in this embodiment, the case of using the light diffusion material capable of transmitting light as the switch operation part 13 is illustrated, but it is not limited to this case, and it could have a transmission part which transmits light emitted by the illumination LED 80e to the side of the operation surface S of the switch operation part 13.

Further, in this embodiment, the case where the joining part 13e had by the switch operation part 13 pinches the illumination LED 80e by the switch operation part 13 and the head part 80d and joins the switch operation part 13 to the head part 80d is illustrated, but it is not limited to this case, and the illumination LED 80e could be pinched by the switch operation part 13 and the head part 80d. For example, it may be constructed so that the side of the head part 80d is provided with a hook part etc. and the illumination LED 80e is pinched by the switch operation part 13 and the head part 80d and the switch operation part 13 is joined to the head part 80d.

What is claimed is:

1. A switch, comprising:
a pressing operation part that is capable of pressing and operating a pressing part;
an LED placed on a flexible printed wiring board and pinched by the pressing operation part and the pressing part;
wherein the pressing operation part has a transmission part for transmitting light emitted by the LED to a side of an operation surface of the pressing operation part.

2. The switch as claimed in claim 1, wherein the pressing operation part or the pressing part has a joining part for pinching the LED by the pressing operation part and the pressing part and joining the pressing operation part to the pressing part.

3. The switch as claimed in claim 1, wherein the LED is provided just under the pressing operation part and is pinched by the pressing operation part and the pressing part so as to abut on the pressing operation part.

4. An illumination unit which includes a switch as claimed in claim 1 and switches between turn-on and turn-off of an illumination part by pressing and operating said switch, characterized in that the flexible printed wiring board has a first connection part for connecting the switch to the illumination part, and a second connection part branched from the first connection part by a slit provided in the flexible printed wiring board, and the LED is placed on the second connection part and is pinched by the pressing operation part and the pressing part.
